(19) United States
(12) Patent Application Publication
(10) Pub. No.: US 2003/0072048 A1
(43) Pub. Date: Apr. 17, 2003

(54) Optical device

(76) Inventor: Tsjerk Hans Hoekstra, Edinburgh (GB)

Correspondence Address: SUGHRUE MION, PLLC, 2100 PENNSYLVANIA AVENUE, N.W., WASHINGTON, DC, 20037, US

(21) Appl. No.: 10/182,201

(22) PCT Filed: Jan. 29, 2001
(86) PCT No.: PCT/GB01/00348

(30) Foreign Application Priority Data
Jan. 28, 2000 (GB) 0002117.0

(51) Int. Cl. G02F 1/00

(52) U.S. Cl. 359/109

(57) ABSTRACT

An optical device comprises a substrate having at least one light-guiding core; a core-modifying element disposed at least partly within the light-guiding core, the core-modifying element being formed of a material different to the substrate material so that the refractive index difference between the material of the core-modifying clement and the light-guiding core is dependent upon the temperature of the core-modifying element; and a heating and/or cooling arrangement for altering the temperature of the core-modifying element.

This invention relates to optical devices.

In the development of optical networks, a technology known as dense wavelength division multiplexing (DWDM) is being extensively investigated.

DWDM employs many closely spaced optical carrier wavelengths. multiplexed together onto a single waveguide such as an optical fibre. The carrier wavelengths are spaced apart by as little as 50 GHz in a spacing arrangement defined by an ITU (International Telecommunications Union) channel “grid”. Each carrier wavelength may be modulated to provide a respective data transmission channel. By using many channels, the data rate of each channel can be kept down to a manageable level, so avoiding the need for expensive very high data rate optical transmitters, optical receivers and associated electronics.

It has been proposed that DWDM can make better use of the inherent bandwidth of an optical fibre link, including links which have already been installed. It also allows a link to be upgraded gradually, simply by adding new channels.

However, one particularly advantageous feature of DWDM is that it allows all-optical routing of telecommunications signals. To implement this aspect of DWDM technology, it is necessary to develop a new range of optical components such as switchers, cross-point networks, channel add-drop multiplexers, variable optical attenuators and so on. It has been proposed that so-called optical integrated circuits offer potential to meet these needs.

The paper, “Novel 2×2 optical switch that has a self-latching function and its applications”, Sakata et al, Proceedings of ECOC'99 pages I-178-179 discloses an optical switching element comprising a planar substrate in which two intersecting waveguide cores are formed. At the junction of the two waveguide cores, a narrow slit perhaps 3 μm across is formed so as to pass through the substrate and through the waveguide cores at an angle to both waveguides. The slit is partly filled with index-matching oil—that is to say, oil having a refractive index substantially matched to that of the waveguide core region formed in the substrate.

Micro-heaters are provided along the slit, so that the oil can be heated up and driven along the slit in either direction. The switch thus has two states. If the oil is moved so as to be in the path defined by the waveguide cores, light passing along the cores experiences no change in refractive index at the junction and so passes through substantially undeviated. If, however, the oil is moved within the slit by the micro-heaters so as not to lie in the path defined by the waveguide cores, light passing along the cores experiences an abrupt chance in refractive index at the edge of the slit and is therefore reflected. By arranging the angle of the slit carefully, the reflection can be into the other intersecting core. So, a switching function is provided.

This switch has the disadvantage of moving parts (the oil) which might lead to long-term reliability problems.

Another technique which has been proposed for providing an optical switching effect in an optical integrated circuit is to make use of the so-called thermo-optic effect. In this proposal, intersecting waveguide cores are formed in a substrate such as a planar silica substrate, and again micro-heaters are fabricated on the substrate. The micro-heaters are themselves carefully angled over the region of intersection of the waveguide cores. When the heaters are operated, the layer stack underneath the heaters rises in temperature, which leads to a change in the refractive index of the heated part of the layer stack. As before, this region of changed refractive index can cause light in one of the waveguide cores to be reflected into another core, providing a switching function.

However, a disadvantage of this arrangement is that the reflection takes place on the edge of the thermal profile generated by the micro-heater. This thermal profile is much less precisely definable than the mechanical profile of the slot formed in the oil-based device.

So, while both devices described above endeavour to provide a useful optical function such as switching by selectively altering the refractive index of a light-guiding core, they both suffer from disadvantages. There is therefore a need for an integrated optical device which avoids or at least alleviates the problems described above.

Various respective aspects of the invention are defined in the appended claims.

This invention also provides an optical device comprising:

a substrate having at least one light-guiding core;

a core-modifying element disposed at least partly within the light-guiding core, the core-modifying element being formed of a material different to the light-guiding core material so that the refractive index difference between the core-modifying element and the light-guiding core is dependent upon the temperature of the core-modifying element; and

a heating and/or cooling arrangement for altering the temperature of the core-modifying element.

The invention addresses the problems described above by providing an optical device in which the refractive index properties of a light-guiding core may be selectively altered, for example (though not exclusively) to perform a switching or similar function, by disposing a core-modifying element at least partly within the core. The core-modifying element is made of a different material to that of the substrate and has different thermal and thermo-optic properties so that when the core-modifying element, or even the whole device, is heated, the refractive index difference between the core-modifying element and the remainder of the core is altered.

The invention thus avoids the need for moving parts but still provides a thermally-driven refractive index modification along a mechanical profile—i.e. along the edge of the core-modifying element.

Embodiments of the invention will now be described with reference to the accompanying drawings, throughout which like parts are referred to by like references, and in which:

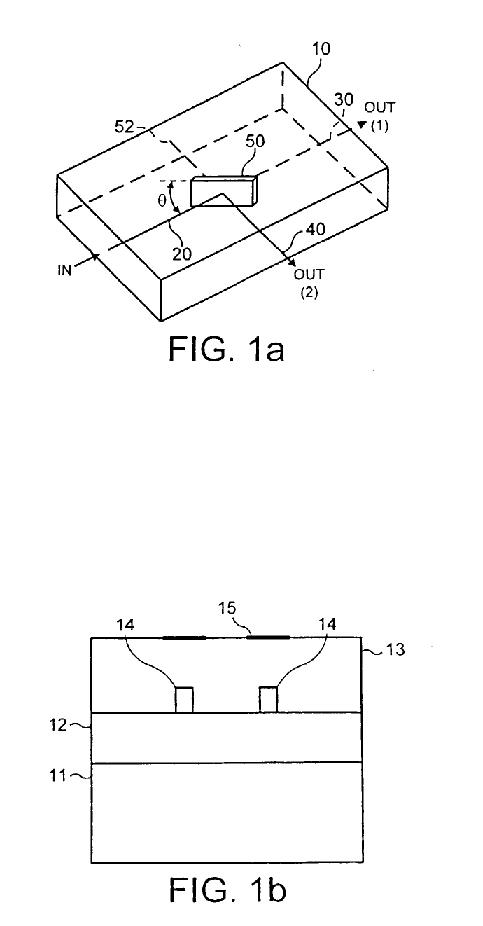

FIG. 1a is a schematic perspective view of an optical switching device;

FIG. 1b is a schematic cross section of a substrate having a waveguide fabricated within it;

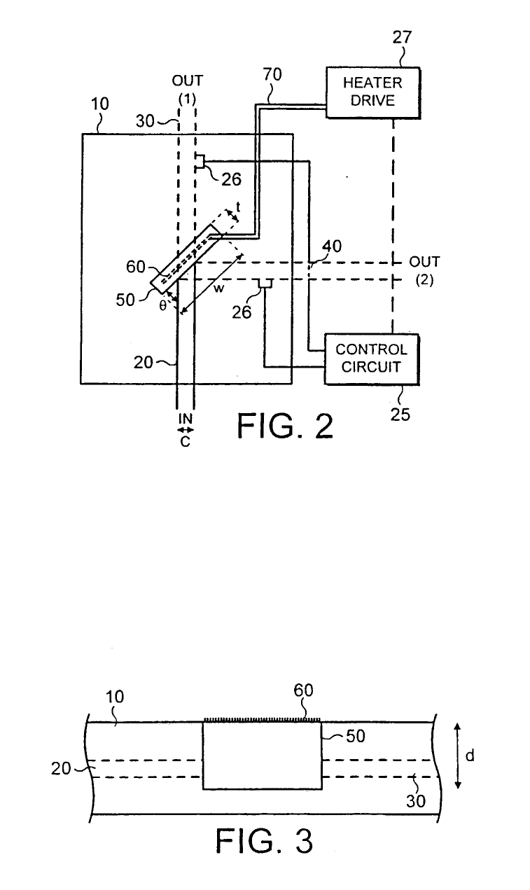

FIG. 2 is a schematic plan view of the device of FIG. 1a;

FIG. 3 is a schematic side elevation of the device of FIG. 1a;

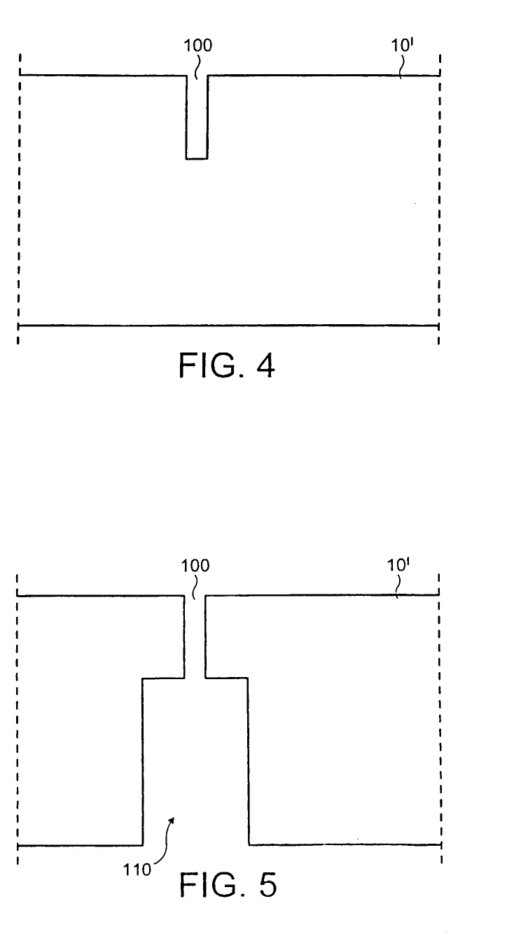

FIGS. 4 to 7 schematically illustrate process steps in one technique of fabricating the device of FIG. 1a;

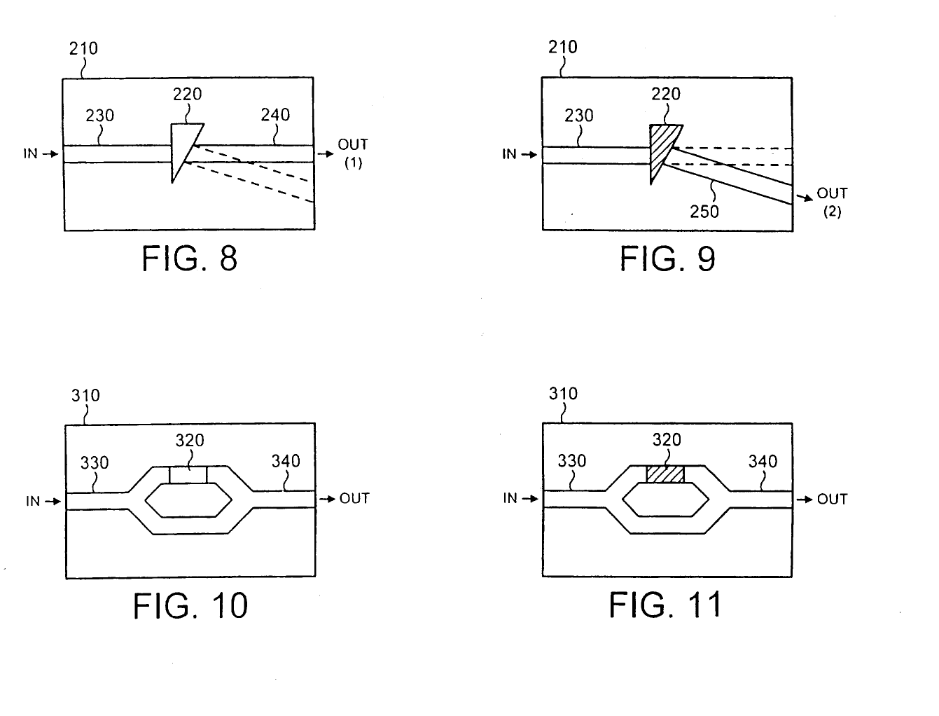

FIGS. 8 and 9 schematically illustrate a second embodiment of an optical switching device:

FIGS. 10 and 11 schematically illustrate a variable optical attenuator:

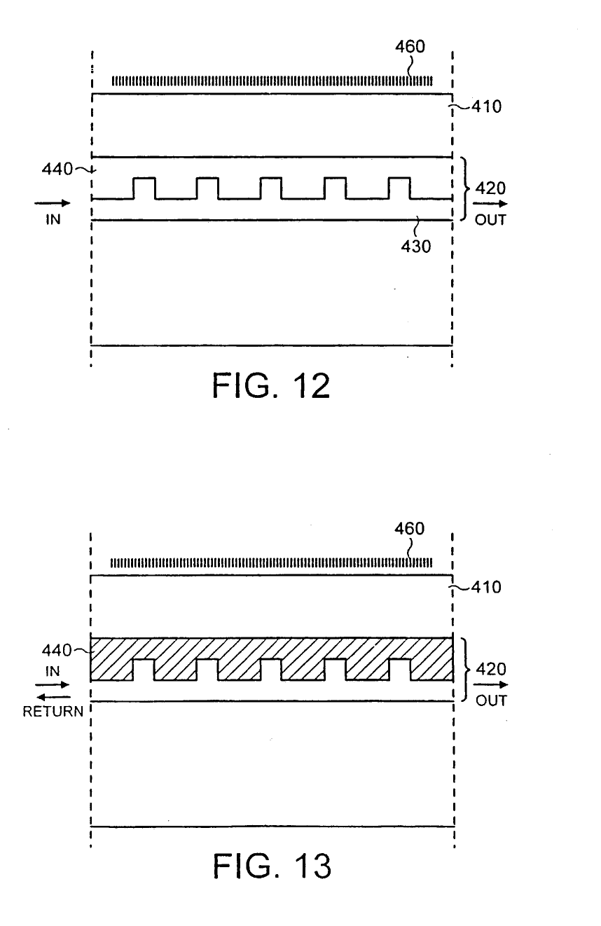

FIGS. 12 and 13 schematically illustrate a switchable optical filter:

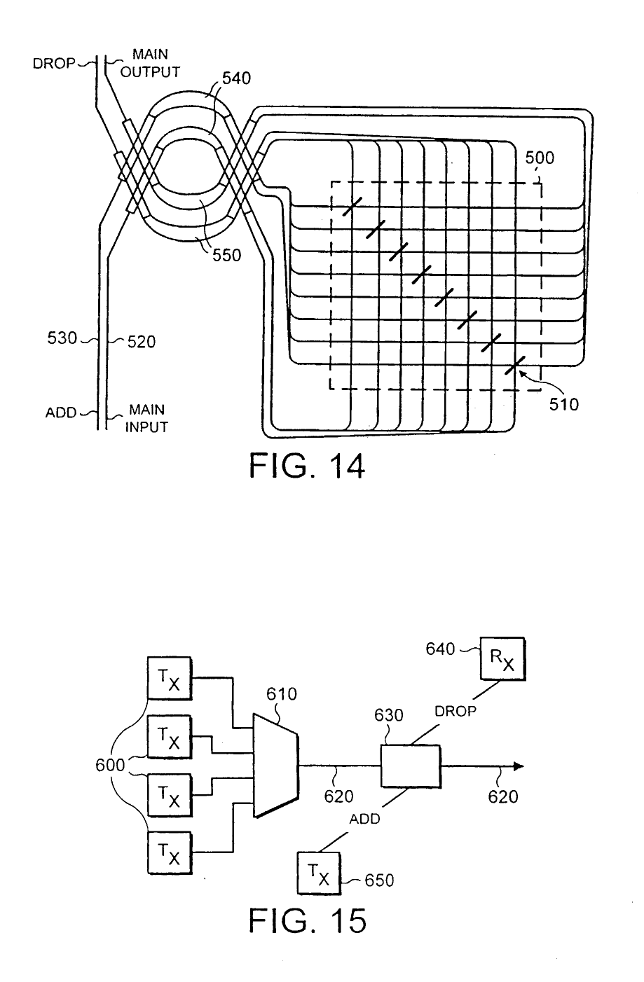

FIG. 14 schematically illustrates an optical channel add/drop multiplexer; and

FIG. 15 schematically illustrates a part of an optical transmission system.

FIG. 1a is a schematic perspective view of an optical switching device. The description of FIG. 1a which follows will provide an overview of the operation of the device but for a more detailed layout of parts not shown on FIG. 1a (such as micro-heaters) reference is made to FIGS. 2 and 3.

The optical switching device comprises a glass substrate 10 in which waveguide cores having paths indicated as 20, 30 and 40 are fabricated by conventional techniques. An index modifying element 50, in this example a polymer element, is disposed in the path 20 of an input core at an angle θ to the core path 20.

The temperature of the core-modifying element 50 can be altered by, for example, micro-heaters (not shown) or Peltier cooling elements (also not shown). This change in temperature can alter the refractive index of the core-modifying element 50. In some preferred embodiments, the rate of change of refractive index of the core modifying element 50 with respect to temperature can be made greater in magnitude than that of the glass substrate 10, and preferably as an opposite sense (sign) to that of the substrate 10, but neither of these features is essential. In any event, when the refractive index of the core modifying element 50 is altered by changing its temperature, the amount of light reflected at the interface between the core path 20 and the core modifying element 50 can be varied. In the case where the temperature of the core modifying element 50 is set so that its refractive index is substantially the same as that of the core regions of the glass substrate 10, light propagating along the input core path 20 will experience no change in refractive index and so will pass to a first output core shown by the path 30. If, however, the temperature of the core modifying element 50 is adjusted so that its refractive index differs from that of the core regions of the substrate 10, then light will be reflected at the interface between the input core and the core modifying element 50. If the angle θ is selected appropriately, then light passing along the input core will be diverted to a second output core shown by the path 40.

In this way, a switching function is performed. In the example shown, there are two possible output ports so that light can be diverted to one or the other. However, if only one output port were provided then the device could still function as a simple on-off switch.

A second input path 52 can be employed, in which case light input along that path may be passed by the element 50 to the second output path 40 or reflected to the first output path 30. By employing both of the input paths 20, 52 and both of the output paths 30, 40, a 2×2 switch arrangement is realised.

In FIG. 1a the core modifying element 50 is shown as being in a plane which is perpendicular to the plane of the core paths 20, 30, 40. However, if the element 50 were angled appropriately then it could provide selective reflection of light from an input core out of the plane of the substrate 10.

FIG. 1b is a schematic cross-section showing the way in which an optical waveguide is formed on a substrate in embodiments of the invention. In the fabrication process used to create the waveguide arrangement, a number of layers of material are deposited. So, a silica waveguide is defined to consist of the following regions:

a substrate 11 of silicon, SiO₂ (silica) or the like

a (possibly doped) silica buffer layer 12 deposited by thermal oxidation or by flame hydrolysis deposition, and of course not required on a silica substrate

a (possibly doped) silica cladding layer 13 deposited by flame hydrolysis (FHD) or plasma enhanced chemical vapour deposition

one or more (possibly doped) cores 14 surrounded by the cladding and buffer regions. The cores may be formed by laying down a layer of core glass by FHD and a consolidation step, then photolithographically masking and etching to form the core paths. The cladding and any other subsequent layers can then be established by FHD.

a thin film heater 15 of metal such as, for example, nichrome, chromium, nickel or tantalum nitride, deposited using standard metal deposition techniques.

For the purposes of characterising an optical waveguide, the following parameters are defined:

| | |
|---|---|
| n_{substrate} | substrate 11 refractive index |
| n_{buffer} | buffer 12 refractive index |
| n_{clad} | cladding 13 refractive index |
| n_{core} | core 14 refractive index |
| t_{substrate} | substrate 11 thickness |
| t_{buffer} | buffer 12 thickness |
| t_{clad} | cladding 13 thickness |
| t_{core} | core 14 thickness |
| w_{core} | core 14 width |

A waveguide fabricated according to embodiments of the invention is defined to possess the following characteristics:

Refractive Index (RI)

n_{core}>n_{clad},n_{buffer}

n_{substrate}>>n_{buffer},n_{clad},n_{core} (for Si substrate)

n_{substrate}≦n_{buffer},n_{clad},n_{core} (for SiO₂ substrate)

Dimensions

t_{substrate}>>t_{clad}+t_{buffer}

t_{clad},t_{buffer}>t_{core}

Suitable materials for the core modifying element include silicone resin, polysilioxane, halogenated silicone resin, halogenated polysilioxane, polyamides, polycarbonates or the like. The rate of change of refractive index for these materials with respect to temperature (dn/dT) is of the order of −1×10⁻⁴ to −5×10⁻⁵ per degree Celsius. This compares with a much smaller and positive dn/dT for typical glass materials of the order of +1×10⁻⁵. The much larger magnitude and opposite sense dn/dT for the polymer material means that the heating of the element 50 does not have to be completely localised to that element—in fact, depending on whether other polymer features requiring independent responses are formed on the same device, the entire device could even be heated or cooled to effect a temperature change of the core modifying element and so vary its response.

The optical switching device of FIG. 1a will now be further described with to reference to FIGS. 2 and 3, where FIG. 2 is a schematic plan view of the device and FIG. 3 is a schematic side elevation of the device.

In FIG. 2, actual waveguide cores are shown along the core paths 20, 30 and 40 corresponding to FIG. 1a. Also shown is a micro-heater 60 fabricated along the upper surface of the core-modifying element 50 and supplied with electrical power by conductors 70 connected to an appropriate power source (not shown). The micro-heater and conductors can be fabricated using conventional techniques for laying down patterns of metal onto a substrate such as an integrated circuit substrate. The micro-heater 60 can be fabricated as simply as providing a narrowed portion of electrical conductor or, to obtain a greater heating effect in a limited space, by arranging a zigzag pattern of narrowed conductor. Since both supply connections are shown as emerging at the same end of the micro-heater 60, the example structure shown is a loop arrangement but this is of course not essential.

A control circuit 25, responsive to optical power detectors 26 associated with the output waveguides can control a heater driver 27. In this arrangement, the temperature of the element 50 is set by a negative feedback process in order to provide the (currently) desired output characteristics of the switch. So, if it is desired that optical power should be routed from the input waveguide to a particular one of the output waveguides, the control circuit 25 will set the temperature of the element 50 (via the heater driver 27) so as to maximise the optical power detected by the detector 26 associated with that output waveguide with respect to the detected power in the other output waveguide.

FIG. 3 is a schematic side elevation which shows the feature that the waveguides are fabricated within the depth of the substrate 10.

The micro-heater 60 may be fabricated on either face of the substrate 10, although if the core modifying element 50 extends only part way through the substrate 10 (as in the example of FIGS. 1 to 3) then a better heating effect can be obtained by heating just the one face as shown in FIG. 3. Similarly, the heaters may be along side the core-modifying element 50 or even, depending on the fabrication technique used, buried within the substrate 10. Of course, there may be a cladding or other layer (not shown) covering the core modifying element 50. The heater may be disposed above that covering layer.

As mentioned above, Peltier or other cooling elements can be used instead of or in addition to one or more heating elements.

The device of FIGS. 1 to 3 may be fabricated by etching a slot in the substrate 10 using a conventional dry etching technique such as reactive ion etching or plasma etching. The slot can then be filled with molten polymer by spin casting. An alternative fabrication technique will now be described with reference to FIGS. 4 to 7.

Referring to FIG. 4, a slot 100 having the desired dimensions of the core modifying element 50 is edged in a substrate 10′ using a dry etching technique such as reactive ion etching or plasma etching.

As shown in FIG. 5, a larger slot 110 is fabricated in the other face of the substrate 10′, against preferably using a dry etching technique.

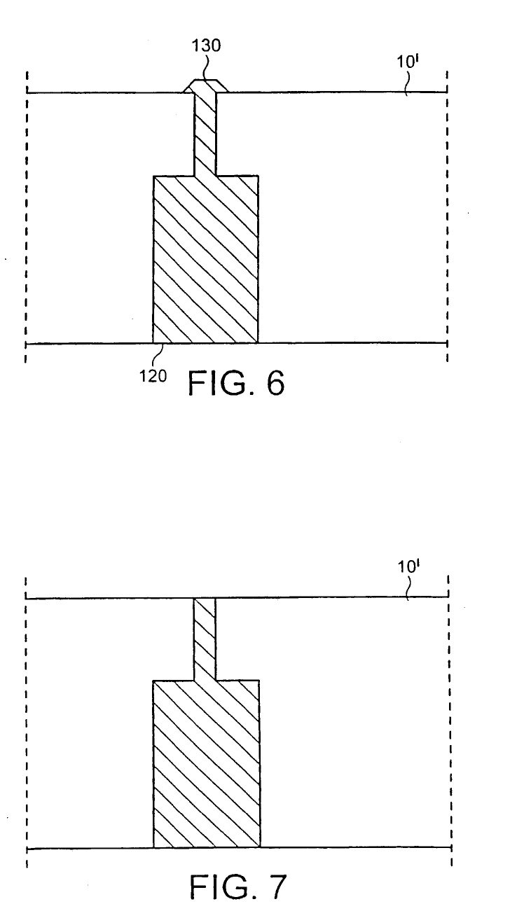

Referring to FIG. 6, molten polymer 120 is introduced into the larger slot 110 and forced through the continuous hole formed by the slots 100 and 110 until it emerges (130) on the opposite face of the substrate 10′. The substrate and polymer arrangement is then allowed to cool so that the polymer solidifies.

Finally, as shown in FIG. 7, the part of the polymer 130 which had emerged from the slot 100 is polished off using a chemical and/or mechanical polishing process to leave a flush substrate surface.

Typical dimensions of the features shown in the above figures are as follows:

Substrate:

t_{substrate}:=675 μm

t_{buffer}=16 μm

t_{clad}=16 μm

Element 50:

dₑₗₑₘₑₙₜ=32 μm

Wₑₗₑₘₑₙₜ=5 mm

tₑₗₑₘₑₙₜ=10 μm

Angle θ=8°

Core:

t_{core}=6 μm

w_{core}=6 μm

A reflection effect is not the only way in which a core-modifying element having a temperature-dependent refractive index could be used to fabricate a useful optical device. FIGS. 8 and 9 schematically illustrate a second embodiment of an optical switching device in which a refraction effect is used.

Referring to FIGS. 8 and 9, a core-modifying element 220 is formed in a substrate 210 using techniques similar to those described above. The illustrations of FIGS. 8 and 9 are schematic plan views, so that the plane of the substrate extends along the page.

The core-modifying element 220 has a varying thickness, for example being shaped like a prism. As before, and as shown in FIG. 8, when the temperature of the core modifying element 220 is set so that its refractive index is the same, or substantially the same, as that of the core regions of the substrate 210, light travelling along an input core 230 is un-deviated and emerges from a first output core 240.

However, when (as shown in FIG. 9) the temperature is adjusted so that the refractive index of the core-modifying element 220 is greater than that of the core regions of the substrate 210, then light is refracted and diverted to a different core. In particular, the arrangement can be such that light travelling along the input core 230 can be diverted to a second output core 250 by the core modifying element 220.

FIGS. 10 and 11 schematically illustrate a further application of this technique in which a core-modifying element is arranged to provide a variable optical attenuation function.

A two-arm interferometer arrangement is set up in a substrate 310 whereby an input core 330 splits into two arms, one of which has disposed within the core a core modifying element 320. The two arms then recombine to form an output core 340.

When the temperature of the core modifying element 320 is set so that its refractive index is the same as that of the core regions of the substrate 310, the optical paths along each of the two arms are identical and light is recombined from the two paths in phase for output. On the other hand, if the temperature of the core modifying clement 320 is altered so that its refractive index differs from that of the core regions of the substrate 310, then the optical path lengths of the two arms can be made to differ causing destructive interference when the light in the two arms recombines. This provides an attenuation or reduction in the amount of light emerging at the output 340.

Of course, a similar arrangement could be made with multiple arms or with arms having path lengths which are not the same even when the refractive index of the core-modifying element is matched to that of the cores.

Finally, FIGS. 12 and 13 schematically illustrate a side elevation of a switchable optical filter. i.e. a device having a wavelength dependent optical transmission or other response.

A substrate 410 has a core 420 fabricated in it. The core is formed partly of glass 430 and partly of a core modifying element (e.g. a polymer) 440. A micro-heater and/or cooling element 460 is provided over or near the core 420.

When the temperature of the core-modifying element 440 is set so that its refractive index is the same as the glass part of the core 430, light propagates along the core 420 undeviated. If, however, the temperature is changed so that the refractive index of the two components of the core differ, then the core becomes a grating formation and, subject to the pitch and other properties of the grating (derivable by conventional techniques) light passing into the core 420 can be partially or totally reflected.

FIG. 14 schematically illustrates an optical channel add/drop multiplexer comprising a substrate having an array 500 of 2×2 switches 510 each similar to the switch described with reference to FIG. 1a.

The two inputs to the multiplexer are a main input 520 carrying a plurality of DWDM channels and an “ADD” input 530 carrying one or more further channels to be added. These two inputs are passed to respective input array waveguide gratings (AWGs) which are known devices serving to map input wavelengths or channels onto respective output waveguides. So, the input signals are broken down into individual wavelength channels which emerge from the AWGs on corresponding individual waveguides.

The individual waveguides from the two AWGs are supplied to the crosspoint matrix 510 of switches. Each switch is a 2×2 switch having two outputs. Depending on the state of the switch, the two outputs of each switch are either (a) the original channel from the main signal on a first output and the ADD channel on a second output, or (b) the ADD channel on the first output and the original channel on the second output.

The “first” outputs of each switch (those departing each switch towards the right hand side of the Figure) are recombined by an output AWG 540 operating in the opposite sense to the input AWG to form the main output of the device. The “second” outputs of each switch (those departing each switch towards the top of the Figure) are recombined by an output AWG into a “DROP” signal.

So, it can be seen that depending on the state of each individual switch, set by respective control electronics, either a main input channel or an “ADD” input channel at each wavelength can be routed to the main output. Similarly, the other one of the main input channel and the “ADD” input channel at each wavelength is routed to the DROP output.

If a 1×2 switch format is used instead, either an add function or a drop function alone can be achieved.

FIG. 15 schematically illustrates a part of an optical transmission system, showing one use of the device of FIG. 14. A plurality of optical signals from transmitters 600 are combined by an optical multiplexer 610 (e.g. a multiplexer of the type shown in FIG. 14 without the “DROP” channels being used) to form a DWDM optical signal. The DWDM optical signal is transmitted along an optical fibre link to a node comprising an add/drop multiplexer 630 (e.g. of the type shown in FIG. 14). Here, a channel is dropped and supplied to a local received 640 and a new channel from a local transmitter 650 is added.

1. An optical device comprising:
a substrate having at least one light-guiding core;
a core-modifying element disposed at least partly within the light-guiding core, the core-modifying element being formed of a material different to the light-guiding core material so that the refractive index difference between the core-modifying element and the light-guiding core is dependent upon the temperature of the core-modifying element; and
a heating and/or cooling arrangement for altering the temperature of the core-modifying element;
wherein the core-modifying element is a refractive element formed and arranged so that a change in the refractive index of the core-modifying element causes light being transmitted along the core to be refracted by the core-modifying element so as to divert the path of the light.

2. A device according to claim 1, comprising a further core for receiving light diverted from the first-mentioned core.

3. An optical device comprising:
a substrate having at least one light-guiding core;
a core-modifying element disposed at least partly within the light-guiding core, the core-modifying element being formed of a material different to the light-guiding core material so that the refractive index difference between the core-modifying element and the light-guiding core is dependent upon the temperature of the core-modifying element; and
a heating and/or cooling arrangement for altering the temperature of the core-modifying element;
wherein the core-modifying element is formed and arranged so that a change in the refractive index of the core-modifying element alters the optical path length of light transmission along the core.

4. A device according to claim 3, comprising:
a further core;
a splitter arranged to split an input optical signal between the further core and the first-mentioned core; and
a combiner arranged to combine light from the further core and the first-mentioned core.

5. An optical device comprising:
a substrate having at least one light-guiding core:
a core-modifying element disposed at least partly within the light-guiding core, the core-modifying element being formed of a material different to the light-guiding core material so that the refractive index difference between the core-modifying element and the light-guiding core is dependent upon the temperature of the core-modifying element; and
a heating and/or cooling arrangement for altering the temperature of the core-modifying element;
wherein the core-modifying element comprises a grating formation formed and arranged such that a change in the refractive index of the core-modifying element alters the wavelength dependence of light transmission along the core.

6. A device according to any one of the preceding claims, in which the rate of change of refractive index with temperature for the material of the core-modifying element has a greater magnitude than the rate of change of refractive index with temperature of the core material.

7. A device according to any one of the preceding claims, in which the rate of change of refractive index with temperature for the material of the core-modifying element has the opposite sense to the rate of change of refractive index with temperature of the core material.

8. A device according to any one of the preceding claims, in which the heating and/or cooling arrangement is arranged so as to alter the temperature of the core-modifying element with respect to the temperature of the light-guiding core.

9. A device according to any one of the preceding claims, in which the heating and/or cooling arrangement comprises one or more electrical heating elements disposed on, over or alongside the core-modifying element.

10. A device according to any one of the preceding claims, in which the heating and/or cooling arrangement comprises one or more electrical cooling elements disposed on or over the core-modifying element.

11. A device according to any one of the preceding claims, in which the core-modifying element is formed of a polymer material.

12. A device according to any one of the preceding claims, in which the heating and/or cooling arrangement is operable to set the temperature of the core-modifying element to a first operating condition in which the refractive index of the core-modifying element is substantially identical to the refractive index of the core, and to a second operating condition in which the refractive index of the core-modifying element is different to the refractive index of the core.

13. An optical switch array comprising a plurality of optical devices according to any one of the preceding claims.

14. An optical channel add and/or channel drop multiplexer comprising a device according to any one of claims 1 to 12.

15. An optical transmission system comprising a device, switch array or multiplexer according to any one of the preceding claims.

16. An optical device substantially as hereinbefore described with reference to FIGS. 1a to 7, FIGS. 8 and 9, FIGS. 10 and 11 and/or FIGS. 12 and 13 of the accompanying drawings.
